(19) United States
(12) Patent Application Publication
(10) Pub. No.: US 2022/0295755 A1
(43) Pub. Date: Sep. 22, 2022

(54) BIRD SEED SCOOPER AND FEEDER

(71) Applicant: Panacea Products Corporation, Columbus, OH (US)

(72) Inventor: Steven Gage, Lakelure, NC (US)

(73) Assignee: Panacea Products Corporation, Columbus, OH (US)

(21) Appl. No.: 17/072,677

(22) Filed: Oct. 16, 2020

(51) Int. Cl. A01K 39/012

(52) U.S. Cl. CPC A01K 39/012

(57) ABSTRACT

A combined birdseed feeder and scooper having its scooper removeably fixed to a valve assembly which enables the scooper to be removeably fixed thereto. Portals are registerable between the bottom of the scooper and the valve assembly to regulate the flow of seed therethrough. The valve assembly is in communication with a bottom disk which maintains a volume of seed therein. The disk has an outer edge which enables a bird to seat thereon and access the seed contained within the base or directly into the valve assembly.

### CROSS REFERENCE TO RELATED APPLICATION

This application is a completion application of co-pending U.S. Provisional Patent Application Ser. No. 62/916,460,filed Oct. 17, 2019for “Combined Birdseed Scooper and Feeder”, the disclosure of which is hereby incorporated by reference in its entirety, including the drawing.

### BACKGROUND OF THE INVENTION

### 1. Field of the Invention

The present invention pertains to a bird feeder, The present invention also pertains to a birdseed scooper. More particularly, the present invention pertains to a combined bird feeder and birdseed scooper.

### 2. Prior Art

As is known to those skilled in the art to which the present invention pertains, traditionally bird feeders involve bird houses and other types of structures which are filled with seed to attract various birds.

Ordinarily, such bird houses or feeders, etc., store a requisite amount of seed which, when depleted, must be refilled.

Typically, the replenishment is a tedious job and, because of the minimal storage volume of the bird feeder, it must continuously be replenished. This is a time-consuming chore.

It is apparent that if there was the ability to store a volume of seed within a bird feeder and an easy way of scooping seed from a source, the maintenance of the feeder is greatly enhanced.

It is to this to which the present invention is directed.

SUMMARY OF THE INVENTION

The combined birdfeeder and scooper hereof generally comprises a base, a support structure, a scooper 16 and a valve or valving, assembly which controls the dispensing of the seed. The base functions as a perch.

The valving assembly includes a toroidal ring which seats atop the disk and through which seed can be dispensed therethrough and into the disk or a bird perched on the disk can directly access seed within the ring.

The scooper portion of the present invention has a cylindrical element which is centrally disposed of the entire assembly. The scooper fixedly secured to the valve. The scooper can be rotated about a vertical axis between an open and closed position whereby seed can be dispensed therethrough into the valving assembly and therefrom into the disk.

For a more complete understanding of the present invention reference is made to the following detailed description and accompanying drawing. In the drawing like reference characters refer to like parts throughout the several views in which:

### DESCRIPTION OF THE DRAWINGS

FIG. 1 is an exploded view of a combined feeder and scooper in accordance with the present invention.

FIG. 2 is a plan view of a fully assembled combined feeder and scooper.

FIG. 3 is a disassembled view of the feeder without the scooper;

FIG. 4 is a partial perspective view of the feeder with the scooper removed;

FIG. 5 is an end view of the bottom of the scooper with the top plate of the valve assembly in a “closed” position;

FIG. 6 is an end view of the top plate of the valve assembly with the gate in the “closed” position;

FIG. 7 is an end view of the scooper with the gate and valve assembly in position; and

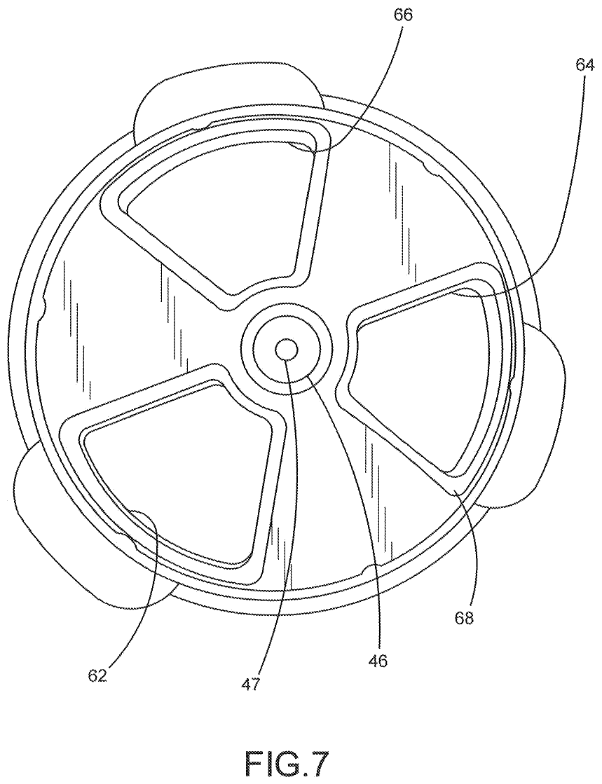

### DESCRIPTION OF THE INVENTION

Now, and with reference to the drawings, there is depicted therein a combined and separable birdseed feeder and scooper, generally denoted at 10.

The combined feeder and scooper, generally comprises a housing 12, having a base 14, a support structure 18, a scooper 16 and a valve or valving assembly 28.

The housing also includes a top or roof 20.

With more particularity, the base 14 comprises a convex disk 22, having a perimetral edge 24 upon which a bird can perch.

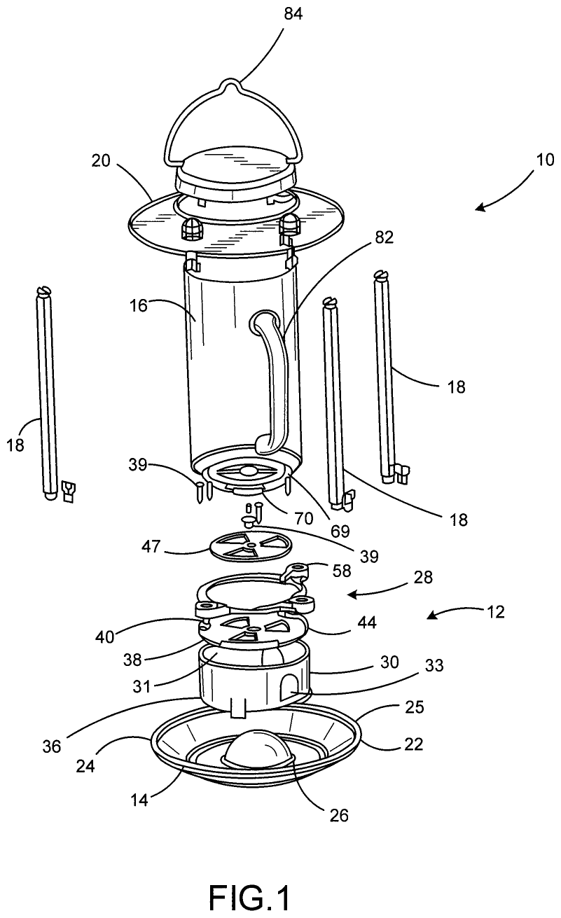

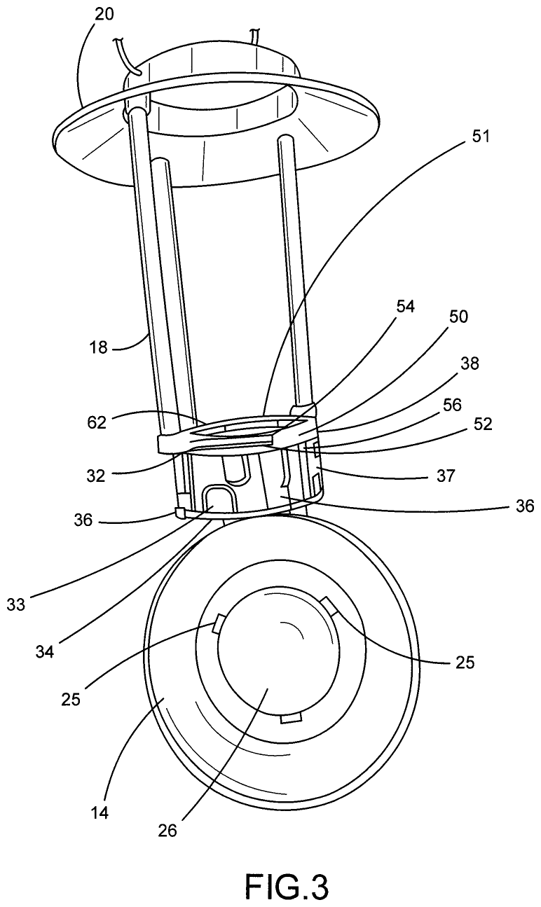

As shown in FIGS. 1 and 3, a plurality of through slots 25 are formed in the disk which receive tabs 36 firmed on the valving assembly 28 to removably mount the valve assembly to the base 14, as described below.

The base 14 has central embossment 26, which is used to evenly distribute seed around the interior of the base.

The valving assembly, generally denoted at 28, is removably seated medially of the disk 22.

The valving assembly 28 comprises a toroidal or cylindrical ring 30 having an open interior or volume 31 for storing bird seed therein. The ring 30 has at least one and, preferably a plurality of access ports or openings 33 formed therein, through which seed can be accessed by a bird or seed discharged therethrough from the interior or volume 31 of the disk.

The ring has a top lip 32, a bottom lip 34 and a medial section 37. Fitted atop and secured to the top lip of the ring with threaded fasteners 39 or the like, is a bottom plate 38.

A plurality of tabs 36 are circumferentially disposed on the ring proximate the bottom lip and project outwardly therefrom. The tabs register with the slots 25 and are removably received therein to seat the valve assembly to the base 14.

The plurality of portals or seed access openings 33 are formed in the medial section or side wall or section 37 of the ring to enable distribution of seed to the disk of the base 14 when seed impinges on the embossment 26.

The bottom plate 38 also has a plurality of central alternating sized openings or apertures 40, 42, 44 which are symmetrically disposed about a central opening 45 with spacers 45′.

As discussed hereinbelow, the openings 40, 42, 44 cooperate with a top plate 46 to regulate the flow of seed into the volume 31 of the interior of the ring.

A central opening 45 is in registry with a central embossment 43 associated with an upper or top valve plate 47.

Referring again to the drawing, the bottom plate 38 is fixedly secured to the top lip of the ring 32. As noted, threaded fasteners, such as screws 39 or the like, project through suitable openings into the plate 38 to secure together the top plate and the bottom plate to the lip.

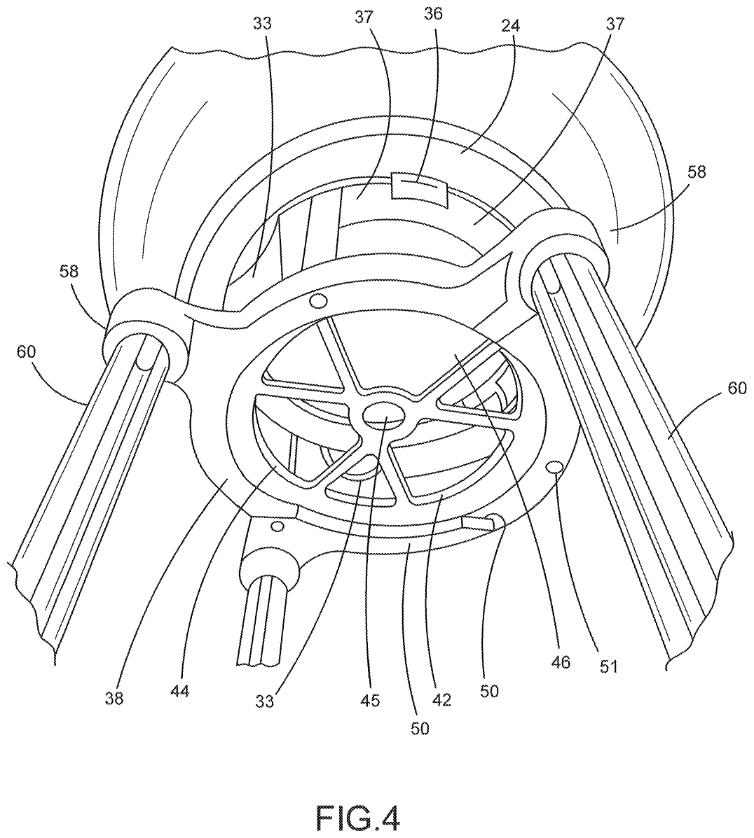

The bottom plate has a plurality of circumferentially disposed upstanding walls 50 (FIG. 4), which cooperate with cut-outs 51 to seat the tabs 70 of the bottom gate of the scooper 16 to the ring, as discussed below.

Each cut-out is in communication with an associated slot 52 to enable the scooper to limitedly rotate about its vertical axis by sliding in the slot. A stop 72 is defined between the upper and lower walls of the ring to enable limited rotation.

As shown, a plurality of linear slots 52 are formed between the top 54 of the walls of the bottom plate 38 and the bottom 56 of the bottom plate 38.

As discussed below, the slots cooperate with at least one tab 70 formed on the scooper 16 to limit rotation of the scooper with respect to the valving assembly 28 and which regulates the flow of seed into the volume 31 of the interior of the ring.

A plurality of receptors 58 laterally project outwardly from the bottom plate 38 and seat support bars or stanchions 60 which extend upwardly therefrom and engage cooperative receptors (not shown) formed in the roof 20.

The receptors and stanchions cooperate to define the support 18.

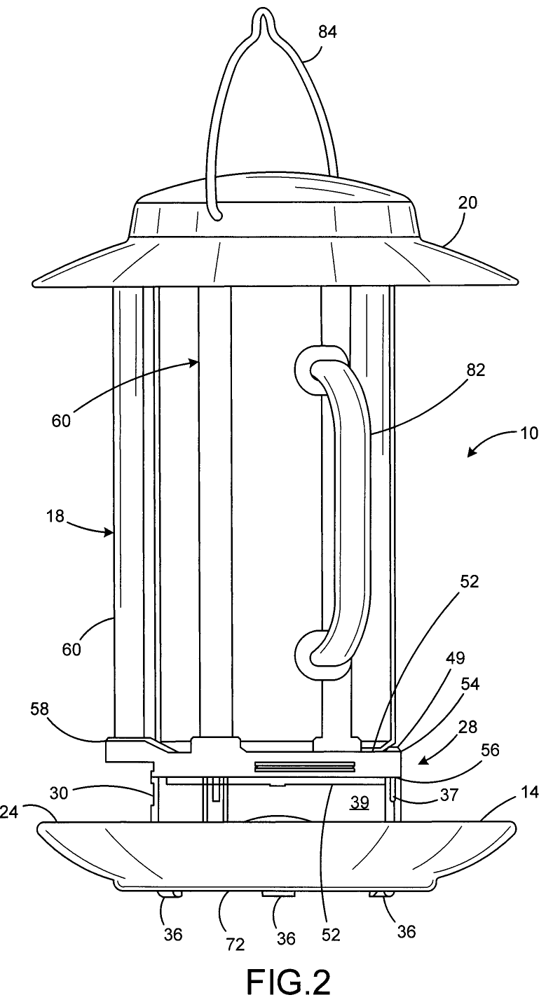

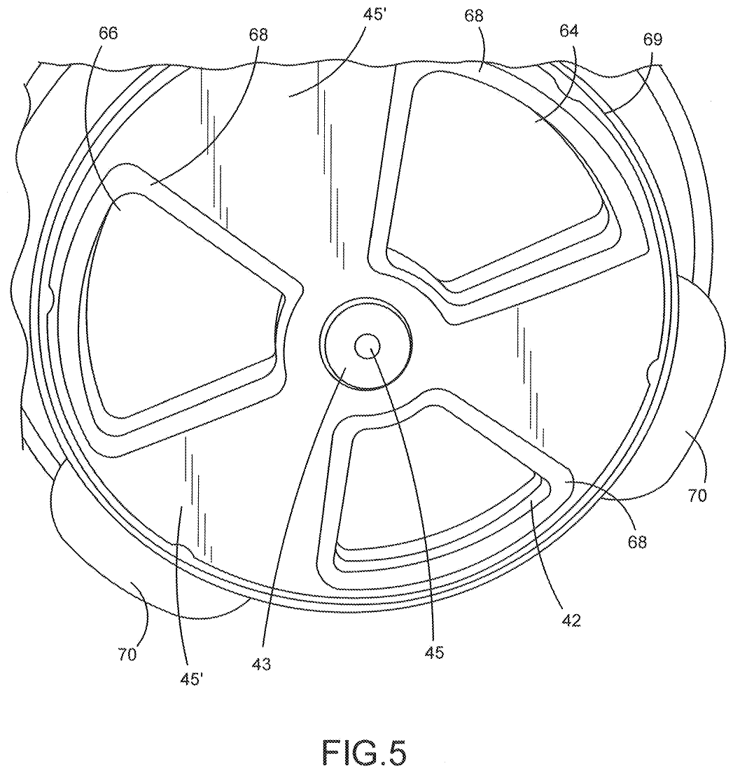

Referring now to FIGS. 1, 2, 3 and 5, there is shown therein the scooper 16. The upper valve plate 48 of the valve assembly is fixedly secured to a bottom gate 49 of the scooper by any suitable means. The central embossment 43 has an opening 48 therethrough and is used to fix the valve plate 47 to the bottom gate 49 of the scooper by any suitable means, such as by press fitting into a companion opening in the scooper bottom gate, or the like.

The embossment defines a pivot about which the bottom gate 49 of the scooper can rotate. The embossment removably seats in the central opening 45 of the bottom plate of the valve assembly.

As shown, the upper valve plate 47 has a plurality of circumferentially disposed portals or openings 62, 64, 66 which permit seed to flow therethrough and into the interior volume of the ring when in registry with openings in the gate 49, as discussed below.

A plurality of side walls 68 surround each of the portals 62, 64, 66 and enable seating or nesting of the upper valve plate in the bottom valve 38, via the side walls of the registering portals. The registering portals are substantially equal in size to those of the larger portals in the lower valve plate.

The scooper 16 is a substantially open topped cylindrical member.

The scooper 16 defining the scooper bottom disk or gate 49, has a plurality of tabs 70 projecting outwardly therefrom. These tabs 70 seat in the cut-outs 50 formed in the valve assembly.

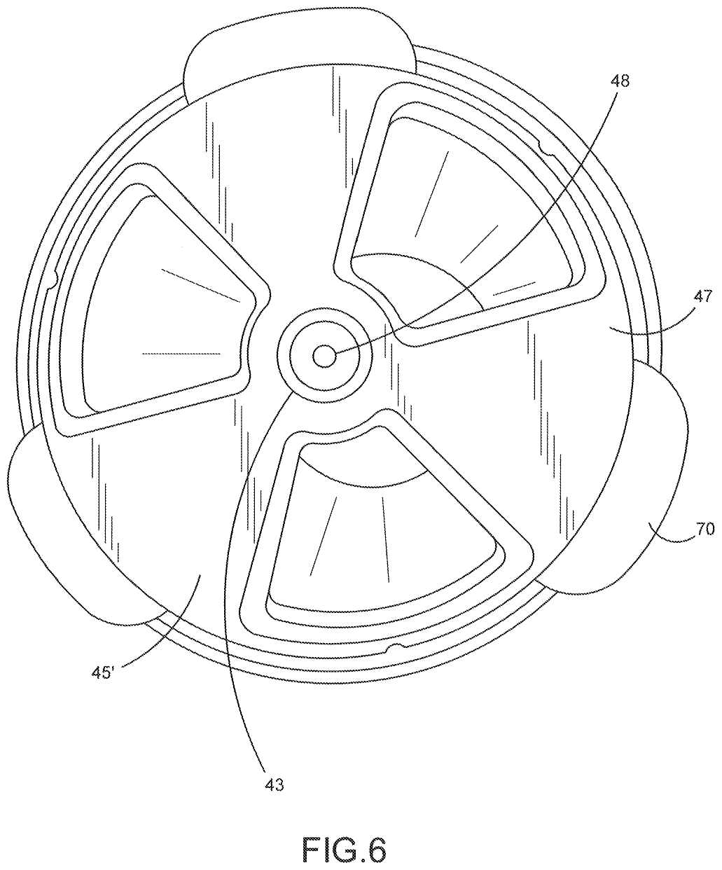

As shown in the drawing, the disk or gate 49 has a plurality of portals 76, 78, 80 which register with the portals in the upper valve plate when rotated to a first position and which close off communication with the ring when in a second position, i.e., when these tabs are seated in its appropriate cut-out and abut their respective stops (FIG. 6).

A handle 82 is integrally formed therewith and facilitates rotation thereof to facilitate rotation of the scooper between the first and second position and grasping the scooper.

As shown in the drawings, the stanchions 60 are spaced apart but have a wider space therebetween at one location thereof. This location enables the scooper to be easily placed in the volume defined between the upper plate of the valve assembly and the roof. This larger space accommodates the handle and permits its rotation about its vertical axis.

A grasping member, such as hook 84 is secured to the top of the roof and enables the bird feeder to be suspended from any suitable spot.

In use, the scooper is initially positioned centrally of the assembly in its “closed” position, such that the tabs 70 seat in their respective associated cut-outs 50. To fill the scooper with seed, the scooper is maintained in its closed position, which closes off communication between the portals 76, 78 and 80 and openings 62, 64 and 66, This permits the scooper to easily be removed from the assembly and to, then, scoop seed from a source.

Once filled, the scooper is repositioned inside the feeder structure while still in its closed position. The handle 82 is then rotated away from the stops to a second or “open” position. In this position, the portals of both the gate and valve plate openings are in registry to permit seed to flow from the scooper through its portals and through the openings 62, 64 and 66 into the interior of the ring, wherefrom it is distributed through the openings 33 and into the disk 22.

It is to be appreciated from the preceding that the combined scooper and bird feeder facilitates maintaining a quantity of seed automatically by placing the scooper in an open position, thereby eliminating the need for a separate scooper. It further provides the convenience of not having to remove the roof to provide seed to the feeder. It also further minimizes spillage of seed to the surrounding environment.

Having, thus, described the invention what is claimed is:

1. A combined bird seed feeder and scooper, comprising:
(a) a convex disk base which defines a perch and a volume for retaining seed therewithin, the base having at least one slot formed therethrough;
(b) a valve assembly seated atop the base, the valve assembly regulating the flow of seed into the disk, the valve assembly having at least one tab insertable into the at least one slot for removably attaching the valve assembly to the base; and
(c) an open-topped scooper comprising a substantially cylindrical member removably positioned atop the valve assembly; and
(d) means for opening and closing the scooper when seated atop the valve and when filling the scooper with seed.

2. The combined birdseed feeder and scooper of claim 1 wherein the valve assembly comprises a toroidal ring having a top lip, a bottom lip, a medial section, an open interior and a plurality of access ports formed circumferentially therearound which define access ports through which seed can be accessed or discharged into the disk, the valve therein including a bottom plate.

3. The combined bird seed feeder and scooper of claim 2 wherein:
the valve assembly further includes a top plate cooperating with the bottom plate to regulate the flow of seed into the volume of the interior of the ring, the bottom plate being fixedly secured to the top lip of the ring, the bottom plate having a plurality of circumferentially disposed upstanding walls for seating the scooper to the ring.

4. The combined bird seed feeder and scooper of claim 3 wherein:
the valve further includes an upper valve plate for fixedly securing the valve assembly to the scooper.

5. The combined bird seed feeder and scooper of claim 1 wherein:
the scooper comprises a bottom gate, the bottom gate being fixedly secured to the upper valve plate, the bottom gate having a central embossment and an opening therethrough, the embossment defining a pivot, bottom gate being rotatable thereabout, the embossment removably seating in the central opening of the bottom plate of the valve assembly.

6. The combined bird seed feeder and scooper of claim 4 wherein:
the upper valve plate has a plurality of circumferentially disposed openings which permit seed to flow therethrough into the interior of the volume of the ring when in registry with the openings of the gate.

5. The combined bird seed feeder and scooper of claim 5 wherein:
the bottom gate has a plurality of portals which register with portals in the upper valve plate when rotated to a first position and which close off communication with the ring when in a second position, the bottom gate having circumferential tabs formed thereon.

8. The combined bird seed feeder and scooper of claim 7 wherein:
the bottom plate has a plurality of circumferentially disposed upstanding side walls which cooperate with cut-outs formed therein which seat the tabs of the bottom gate of the scooper onto the ring.
